(19) United States
(12) Patent Application Publication
(10) Pub. No.: US 2012/0191496 A1
(43) Pub. Date: Jul. 26, 2012

(54) SYSTEM AND METHOD FOR USE IN A CONDITION-BASED REPAIR PROCESS

(76) Inventors: David Stephen Muench, Simpsonville, SC (US); Michael Edward Bernard, Simpsonville, SC (US); Christopher Dean Higgins, Greenville, SC (US); Thomas Bradley Beddard, Marietta, GA (US)

(21) Appl. No.: 13/012,022

(22) Filed: Jan. 24, 2011

(51) Int. Cl. G06Q 10/00

(52) U.S. Cl. 705/7.13; 705/7.11; 705/7.12

(57) ABSTRACT

A method of determining component repair activities includes providing a computer-based component workscope routing system. The method also includes making a first determination of eligibility of a component for one of a standardized repair workscope that includes a plurality of predetermined standardized repair workscope activities, and an enhanced repair workscope. The enhanced repair workscope includes at least one of a number of enhanced repair workscope activities that is less than a predetermined number of standardized repair workscope activities, and inspection and repair activities that are different in scope from the plurality of standardized repair workscope activities. The method further includes making a second determination of eligibility of the component for the standardized repair workscope or the enhanced repair workscope.

### BACKGROUND OF THE INVENTION

The embodiments described herein relate generally to repair methods and processes and, more particularly, to network-based component workscope routing systems for determining condition-based repairs repair in high-value assets.

At least some known maintenance repair processes for high-value assets use standardized inspection and repair methods that are applied to all similar pieces of equipment. For example, during many known routine maintenance overhauls of large, complex, high-value assets, such as industrial gas turbine engines, typically thousands of individual components are processed through a standardized workscope. Such standardized workscopes may include incoming inspections, disassembly, and corrective repair procedures that are applied to each component. In some instances, it has been logistically convenient to repair components regardless of the actual condition of each component. As a result, components having little or no defects may be processed with a similar expenditure of resources as those components having significant defects. This expenditure of resources is considered to be suboptimal from a financial perspective.

Some known maintenance repair processes rely on uniformity of the inspection procedures. However, the level of uniformity is often dependent on the experience of an inspector, and/or their subjective interpretation of inspection guidelines. Accordingly, the costs of maintenance overhauls may be substantially increased to accommodate unnecessary maintenance activities.

### BRIEF DESCRIPTION OF THE INVENTION

In one aspect, a method of determining component repair activities is provided. The method includes providing a computer-based component workscope routing system. The method also includes making a first determination of eligibility of a component for one of a standardized repair workscope that includes a plurality of predetermined standardized repair workscope activities, and an enhanced repair workscope. The enhanced repair workscope includes at least one of a number of enhanced repair workscope activities that is less than a predetermined number of standardized repair workscope activities, and inspection and repair activities that are different in scope from the plurality of standardized repair workscope activities. The method further includes making a second determination of eligibility of the component for the standardized repair workscope or the enhanced repair workscope.

In another aspect, a network-based component workscope routing system is provided. The system includes at least one computing device. The computing device includes a memory device configured to store data associated with a component and at least one input channel. The input channel is configured to receive the data associated with the component. The computing device also includes a processor coupled to the memory device and the at least one input channel. The processor is programmed to route the component to one of a standardized repair workscope and an enhanced repair workscope. Such routing is a function of at least one pre-inspection manual entry into the network-based component workscope routing system via the at least one input channel. The entry determines eligibility for further evaluation of the component as a candidate for the enhanced repair workscope. Such routing is also a function of emergent post-inspection component data transmitted into the network-based component workscope routing system via the at least one input channel.

In yet another aspect, one or more computer-readable storage media is/are provided. The storage media has computer-executable instructions embodied thereon. When executed by at least one processor, the computer-executable instructions cause the at least one processor to generate a first determination that a component is eligible for one of a standardized repair workscope and an enhanced repair workscope based on a pre-inspection manual selection entry transmitted into the processor. The computer-executable instructions cause the at least one processor to generate a second determination that the component is eligible for one of the standardized repair workscope and the enhanced repair workscope. The second determination is at least partially based on legacy component data existing when the pre-inspection manual selection was entered and emergent post-inspection component data transmitted into the processor.

### BRIEF DESCRIPTION OF THE DRAWINGS

The embodiments described herein may be better understood by referring to the following description in conjunction with the accompanying drawings.

FIG. 1 is a block diagram of an exemplary computing device;

FIG. 2 is block diagram of an exemplary computer-based component workscope routing system;

FIG. 3 is a schematic view of an exemplary gas turbine engine, a magnified view of an exemplary combustor assembly taken about an area A, and a magnified view of an exemplary transition piece taken about an area B;

FIG. 4 is an exemplary flow chart illustrating an exemplary assembly hierarchy of the gas turbine engine shown in FIG. 3;

FIG. 5 is an exemplary flow chart illustrating an exemplary method that may be used to perform an eligibility assessment for a condition-based repair of a component, such as the combustor assembly shown in FIG. 3;

FIG. 6 is a flowchart of an exemplary method of applying Internet-based component routing;

FIG. 7 is a flowchart of an exemplary method of applying component-specific inspection and repair guidelines;

FIG. 8 is a table of exemplary incoming component information and data structure;

FIG. 9 is a diagram of exemplary database information;

FIG. 10 is a flowchart of an exemplary workscope decision engine;

FIG. 11 is a table of an exemplary repair listing and routing; and

FIG. 12 is a diagram of exemplary enhanced repair workscope generation.

### DETAILED DESCRIPTION OF THE INVENTION

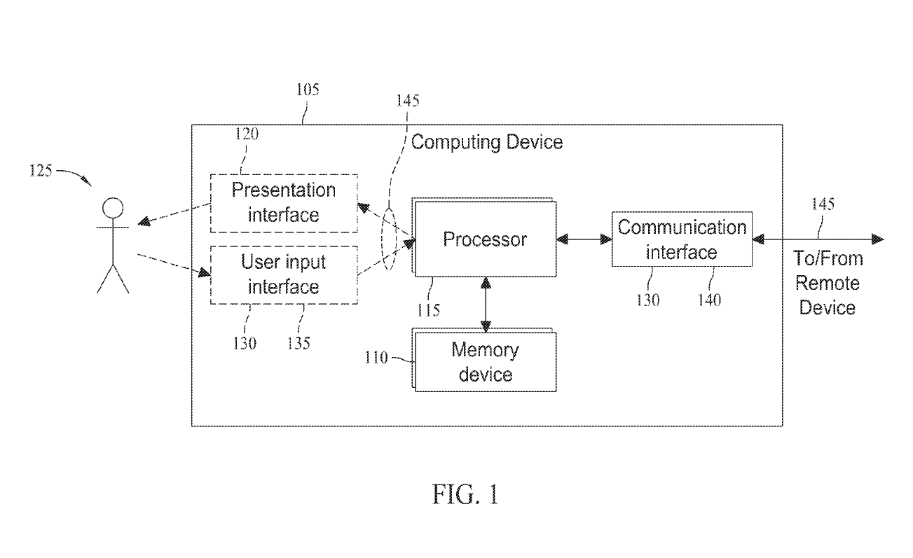

FIG. 1 is a block diagram of an exemplary computing device 105. In the exemplary embodiment, computing device 105 includes a memory device 110 and a processor 115 coupled to memory device 110 for executing instructions. In some embodiments, executable instructions are stored in memory device 110. Computing device 105 performs one or more operations described herein by programming processor 115. For example, processor 115 may be programmed by encoding an operation as one or more executable instructions, thus providing executable instructions to memory device 110. Processor 115 may include one or more processing units (e.g., in a multi-core configuration).

Memory device 110 is one or more devices that enable transmission of information, e.g., executable instructions and/or other data to be stored and retrieved. Memory device 110 may include one or more computer readable media, such as, without limitation, dynamic random access memory (DRAM), static random access memory (SRAM), a solid state disk, and/or a hard disk. Memory device 110 may be configured to store, without limitation, computer-executable instructions, standardized repair workscopes and activities, enhanced repair workscopes and activities, component-specific physical configuration data, component-specific operational history data, enhanced repair workscope guidelines, predefined component screening questions, descriptions of inspection criteria for specific defect types, results of condition-based inspections, types of component repair activities, levels of disassembly to perform the component repair activities, predefined defect parameters, comparisons of component physical condition data and the predefined defect parameters, repair procedures for the component, and comparisons of actual repair resource expenditures with estimated repair resource expenditures, repair data (e.g., materials and/or labor required to repair a production asset), and/or any other type of data. In some embodiments, memory device 110 stores asset attribute data, such as model number, drawing number, component physical attributes, and/or operating specifications of selected components therein.

In some embodiments, computing device 105 includes a presentation interface 120 that is coupled to processor 115. Presentation interface 120 presents information, such as a user interface, application source code, input events, and/or validation results to an administrator, or user 125. For example, presentation interface 120 may include a display adapter (not shown in FIG. 1) that may be coupled to a display device, such as a cathode ray tube (CRT), a liquid crystal display (LCD), an organic LED (OLED) display, and/or an “electronic ink” display. In some embodiments, presentation interface 120 includes one or more display devices. In addition to, or in the alternative, presentation interface 120 may include an audio output device (e.g., an audio adapter and/or a speaker) and/or a printer.

In some embodiments, computing device 105 includes an input interface 130, such as a user input interface 135 or a communication interface 140. Input interface 130 may be configured to receive any information suitable for use with the methods described herein.

In the exemplary embodiment, user input interface 135 is coupled to processor 115 and receives input from user 125. User input interface 135 may include, for example, a keyboard, a pointing device, a mouse, a stylus, a touch sensitive panel (e.g., a touch pad or a touch screen), a borescope, a camera, a coordinate measuring machine, and/or an audio input interface (e.g., including a microphone). A single component, such as a touch screen, may function as both a display device of presentation interface 120 and user input interface 135.

Communication interface 140 is coupled to processor 115 and is configured to be coupled in communication with one or more remote devices, such as another computing device 105 via at least one input/output channel 145. For example, communication interface 140 may include, without limitation, a serial communication adapter, a wired network adapter, a wireless network adapter, and/or a mobile telecommunications adapter. Communication interface 140 may also transmit data to one or more remote devices. For example, a communication interface 140 of one computing device 105 may transmit predicted production asset failures, correction scenarios, cost information, and/or maintenance tasks to the communication interface 140 of another computing device 105. Moreover, an input/output channel 145 may be used to facilitate communication between processor 115 and presentation interface 120 and user input interface 135.

In the exemplary embodiment, one particular architecture for computing device 105 is shown. Alternatively, any computing architecture that enables computing device 105 as described herein is used.

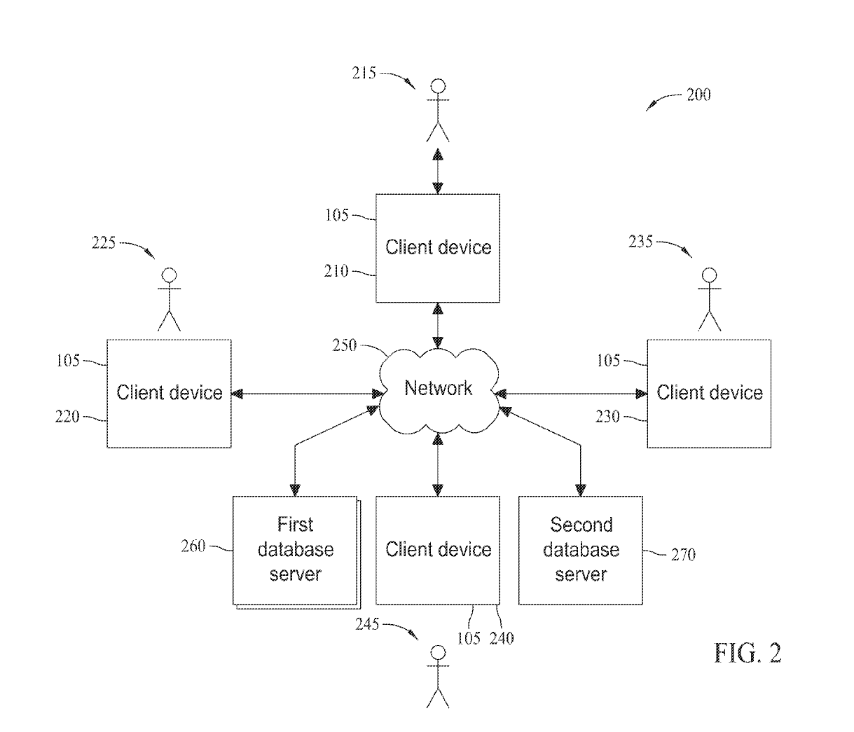

FIG. 2 is block diagram of an exemplary computer-based component workscope routing system 200. System 200 includes a first client device 210 that, in the exemplary embodiment, is substantially similar to computing device 105. In the exemplary embodiment, first client device 210 is operated by a first user, e.g., an equipment maintainer 215. Equipment maintainer 215 is defined herein as a user that has at least some responsibilities for operation and maintenance of high-value assets, e.g., gas turbine engines (not shown). System 200 also includes a second client device 220 that is substantially similar to first client device 210, and that is operated by a second user, e.g., a reviewer 225. A reviewer is defined herein as a user that has at least some responsibilities for reviewing suggested maintenance activities made by equipment maintainer 210.

System 200 further includes a third client device 230 that is substantially similar to first client device 210, and that is operated by a third user, e.g., an inspector 235. An inspector 235 is defined herein as a user that physically inspects at least some of the components (not shown in FIG. 2) from the high-value assets provided for inspection by equipment maintainer 210. System 200 also includes a fourth client device 240 that is substantially similar to first client device 210, and that is operated by a fourth user, e.g., repair shop personnel 245. Repair shop personnel 245 are defined herein as users that have at least some responsibilities for repairs and other maintenance activities associated with components (not shown in FIG. 2) shipped from the high-value assets provided by equipment maintainer 210. Equipment maintainer 215, reviewer 225, inspector 235, and repair shop personnel 245 interact with client devices 210, 220, 230, and 240, respectively, via user input interface 135 and/or presentation interface 120 (both shown in FIG. 1).

Workscope routing system 200 at least partially defines a network 250. Client devices 210, 220, 230, and 240 are coupled in communication via network 250 and each is substantially similar to computing device 105. In the exemplary embodiment, each of client devices 210, 220, 230, and 240 is coupled to network 250 via communication interface 140 (shown in FIG. 1). Network 250 may include, without limitation, the Internet, a local area network (LAN), a wide area network (WAN), a wireless LAN (WLAN), a mesh network, and/or a virtual private network (VPN). While certain operations are described below with respect to particular computing devices 105, including client devices 210, 220, 230, and 240, it is contemplated that any computing device 105 may perform one or more of the described operations. For example, first client device 210 may perform all of the operations described herein.

Network 250 also facilitates coupling at least a first database server 260 to each of client devices 210, 220, 230, and 240. First database server 260 is programmed with a relational database that includes, without limitation, records containing legacy component data that includes component-specific physical configuration data and operational history data existing at the time of a pre-inspection manual entry into system 200 by equipment maintainer 215 (described further below). Such legacy component data may include, without limitation, performance and repair data that has been generated during prior reliability analyses. Such data may also include data referencing the components to a proprietary component marking scheme.

First database server 260 also includes a relational database that includes, without limitation, a plurality of predefined defect parameters, e.g., defined numerically and specific to each defect type and component for which data is requested, e.g., quantitative definitions as to what constitutes a defect in a component that may be inspected by inspector 235. Moreover, first database server 260 includes subsystem-specific and component-specific maintenance applicability guidelines that define those maintenance actions applicable to the associated subsystems and components.

First database server 260 further includes a relational database that includes, without limitation, inspection forms specific to the high-value asset and each subsystem and component therein, with screening questions and a listing of defects that are customized for each unique subsystem and component that may be used by inspector 235. First database server 260 also includes a relational database that includes, without limitation, instructions for repair shop personnel 245 to properly screen and record defect data for a component to be repaired. These instructions include key attributes, e.g., without limitation, a listing of eligible components and a cross-referencing of key engineering part identifiers with physical component attributes, instructions for the proper marking of components upon the completion of all repairs, and a series of annotated images and schematics that describe the defects for which data is requested.

Network 250 also facilitates coupling at least one second database server 270 to each of client devices 210, 220, 230, and 240. Second database server 270 is programmed with a relational database that includes, without limitation, records containing repair procedures for the components and subsystems of the high-value assets.

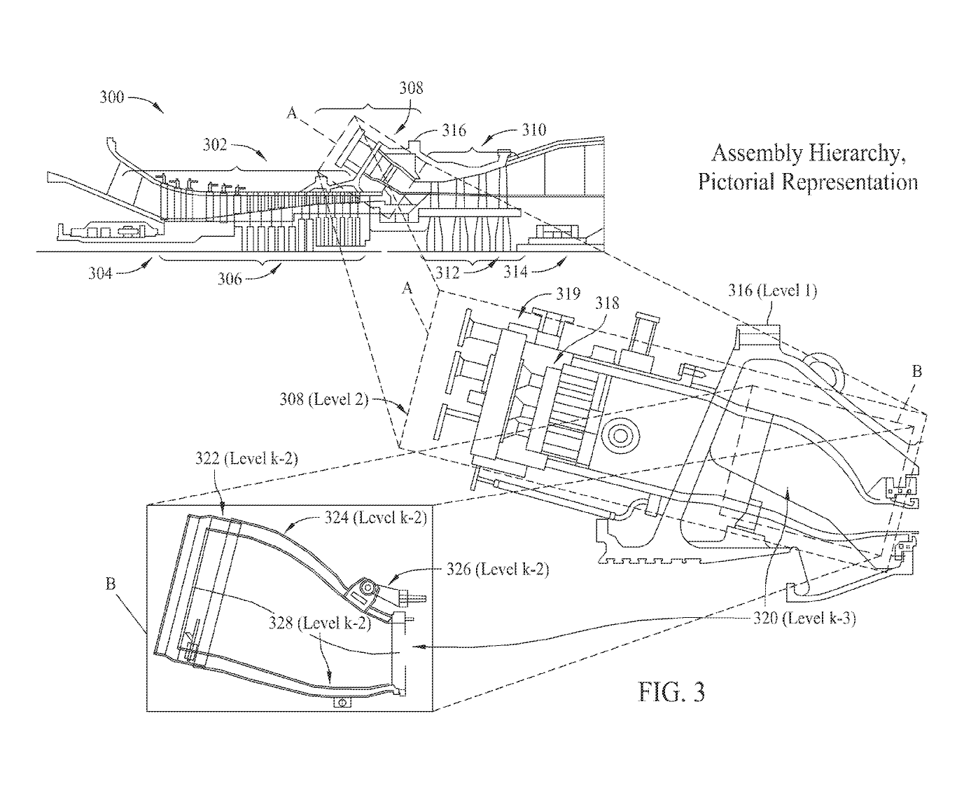

FIG. 3 is a schematic view of an exemplary large, complex, high value asset, e.g., a gas turbine engine 300. Alternatively, other high-value assets may include electro-mechanical systems including, without limitation, wind turbine generators, variable frequency drives, steam turbines, and electric transmission circuit breakers. In the exemplary embodiment, gas turbine engine 300 is a high-value asset that includes a compressor section 302 that includes a forward bearing assembly 304 and a forward wheel assembly 306. Gas turbine engine 300 also includes a combustor assembly 308, shown within an area A. Gas turbine engine 300 further includes a hot section 310 that includes an aft wheel assembly 312 and an aft bearing assembly 314. Gas turbine engine 300 also includes a casing 316 that extends about at least a portion of engine 300, and extends about a portion of combustor assembly 308.

FIG. 3 also shows a magnified schematic view of exemplary combustor assembly 308 taken about area A. In the exemplary embodiment, combustor assembly 308 includes a fuel nozzle assembly 318, a cap assembly 319, and a transition piece assembly 320, shown within area B. FIG. 3 further shows a magnified schematic view of exemplary transition piece assembly 320 taken about area B. Also, in the exemplary embodiment, transition piece assembly 320 includes a forward ring assembly 322, a main body 324, an aft frame 326, and an impingement sleeve 328. Transition piece assembly 320 may have defects that include, without limitation, body cracking, spallation, bulging, bracket cracking, and seal land wear (neither shown). Cap assembly 319 may have defects that includes, without limitation, spring seal cracking, spring seal wear, and missing fingers (neither shown).

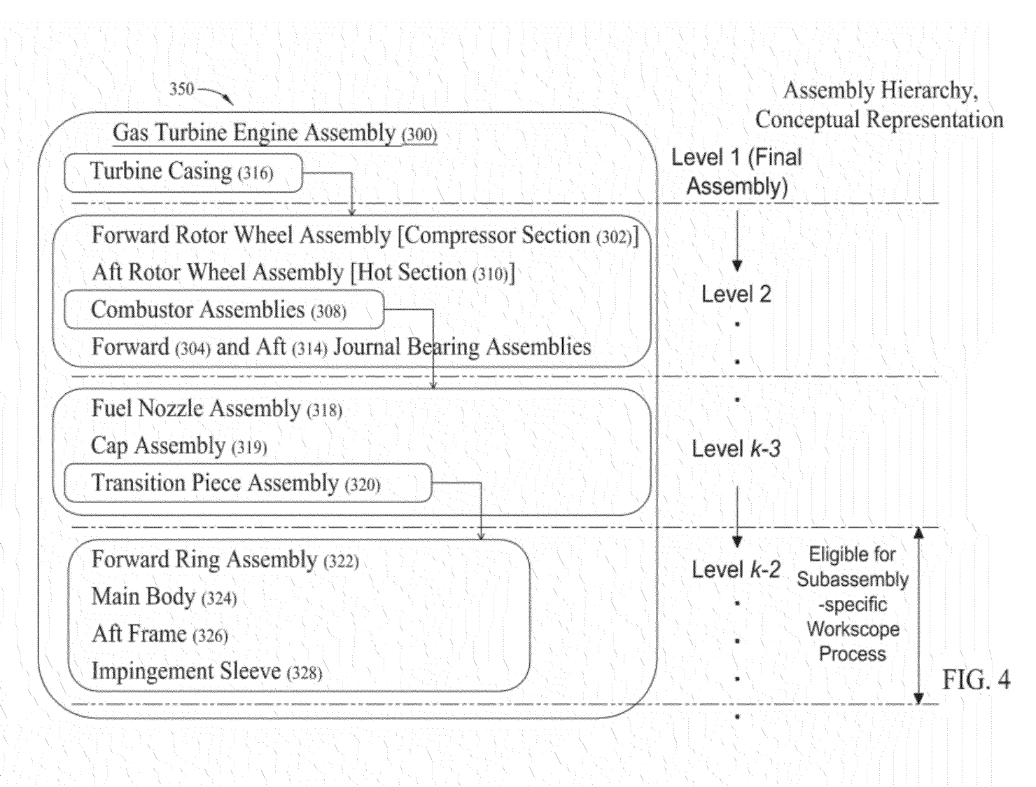

FIG. 4 is an exemplary flow chart illustrating an exemplary assembly hierarchy 350 of gas turbine engine 300 (shown in FIG. 3). Assembly hierarchy 350 includes a plurality of assembly levels that also define levels of disassembly. Assembly hierarchy 350 includes a final assembly level, or Level 1. In the exemplary embodiment, casing 316 (shown in FIG. 3) is considered to be a Level 1 system. Also, in the exemplary embodiment, forward bearing assembly 304, forward wheel assembly 306, combustor assembly 308, aft wheel assembly 312, and aft bearing assembly 314 (all shown in FIG. 3) are considered to be subsystem, or Level 2 subassemblies. Further, in the exemplary embodiment, fuel nozzle assembly 318, cap assembly 319, and transition piece assembly 320 (all shown in FIG. 3) are considered to be Level k-3 components, where “k” is the total number of assembly levels that at least partially define the high-value electro-mechanical system, e.g., gas turbine engine 300. Also, in the exemplary embodiment, forward ring assembly 322, main body 324, aft frame 326, and impingement sleeve 328 (all shown in FIG. 3) of transition piece assembly 320 are considered to be Level k-2 components that are eligible for a subassembly-specific workscope process (not shown in FIG. 4) via computer-based component workscope routing system 200 (shown in FIG. 2).

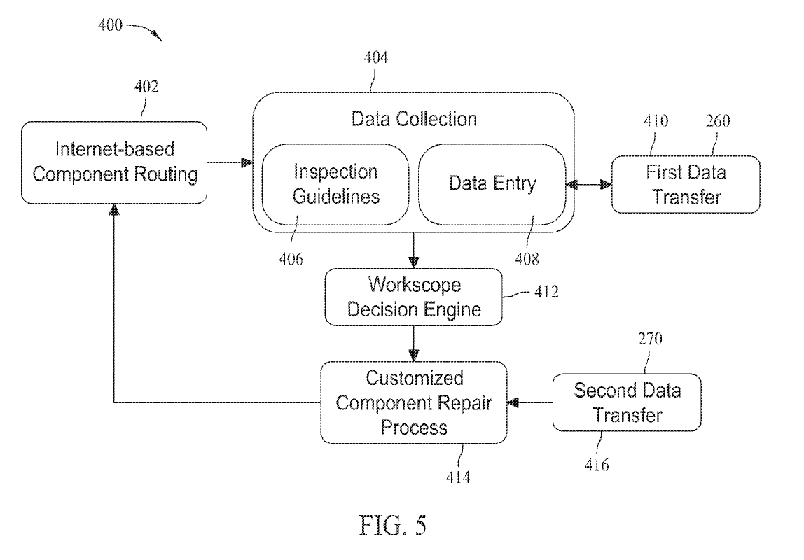

FIG. 5 is an exemplary flow chart illustrating an exemplary method 400 that may be used to perform an eligibility assessment for a condition-based repair of a Level 2 subassembly, e.g., combustor assembly 308 (shown in FIG. 3), or a Level k-3 component, e.g., transition piece 330 (shown in FIG. 3). In the exemplary embodiment, a routing element 402 is used that, in the exemplary embodiment, is network-based, e.g., an Internet-based application, wherein computer-based component workscope routing system 200 (shown in FIG. 2) determines what subsystems and components are eligible for an enhanced repair process. Alternatively, routing element 402 is adaptive to any network 225 (shown in FIG. 2). System 200 directs users, e.g., equipment maintainer 215 and reviewer 225 (both shown in FIG. 2) to enter asset specific operational and identification data. In the exemplary embodiment, such data is associated with combustor assembly 300 (at the subsystem level) (shown in FIG. 3) and combustor cap assembly 302 and transition piece 312 (at the component level) (both shown in FIG. 3). Such data is typically input routinely during the lifetime of the subsystems and components. In the event of such subsystems and components requiring maintenance, system 200 provides status and direction to equipment maintainer 215 as to whether or not they can proceed to the next stage in directing such subsystem and components to an enhanced repair workscope, or alternatively, route the equipment to the standard repair workscope.

In general, and as used herein, the term “standardized repair workscope” includes a plurality of predetermined standard repair workscope activities. Also, as used herein, the term “enhanced repair workscope” includes a workscope that has at least one of a number of enhanced repair workscope activities that is less than the predetermined number of standardized repair workscope activities, and inspection and repair activities that are different in scope from the standardized repair workscope activities. In some embodiments, such enhanced repair workscope and activities may be optimized, e.g., the workscope and activities are as efficient as possible.

A data collection element 404 is used, wherein asset specific guidelines direct the end user, e.g., inspector 235 on how to identify incoming subsystem and component condition. In the exemplary embodiment, a combination of text, schematics, and photographs aid inspector 235 in the proper characterization of incoming subsystem and component defects. For example, in the exemplary embodiment, data collection element 404 includes two elements, i.e., an inspection guidelines element 406 and a data entry element 408.

A first data transfer element 410 is used, that enables data to be transmitted from first database server 260 to system 200. A workscope decision engine element 412 is used. Workscope decision engine element 412 incorporates recorded incoming inspection data, predefined defect limits, and logic that govern pass/fail criteria and a level of disassembly of the subsystems, e.g., combustor assembly 300, and/or the components, e.g., combustor cap assembly 302 and transition piece 312. Such level of disassembly may include, without limitation, collateral removal to gain access to the subsystems and components, and for example, removal of transition piece 312 from combustor assembly 300 to facilitate a visual observation of a defect such as thermal barrier coating.

A customized component repair process element 414 is used to facilitate effectively routing affected subsystems and components to an enhanced repair workscope. The unique, customized, and enhanced workscope, including a list of repairs based upon the incoming condition of the subsystems and components, is defined by inputs from a database of defect-specific repair procedures, e.g., from database server 270. Method 400 also includes a second data transfer element 416, wherein data is transmitted from second database server 270 to system 200. Once the enhanced repair workscope is generated, it is transmitted via component routing element 402 to all associated repair team members and the associated sites, e.g., without limitation, equipment maintainer 215 at the asset site (not shown) and inspector 235 at the inspection site (not shown) that is, most likely, in a location different from the asset site. Each element of method 400 is discussed further below.

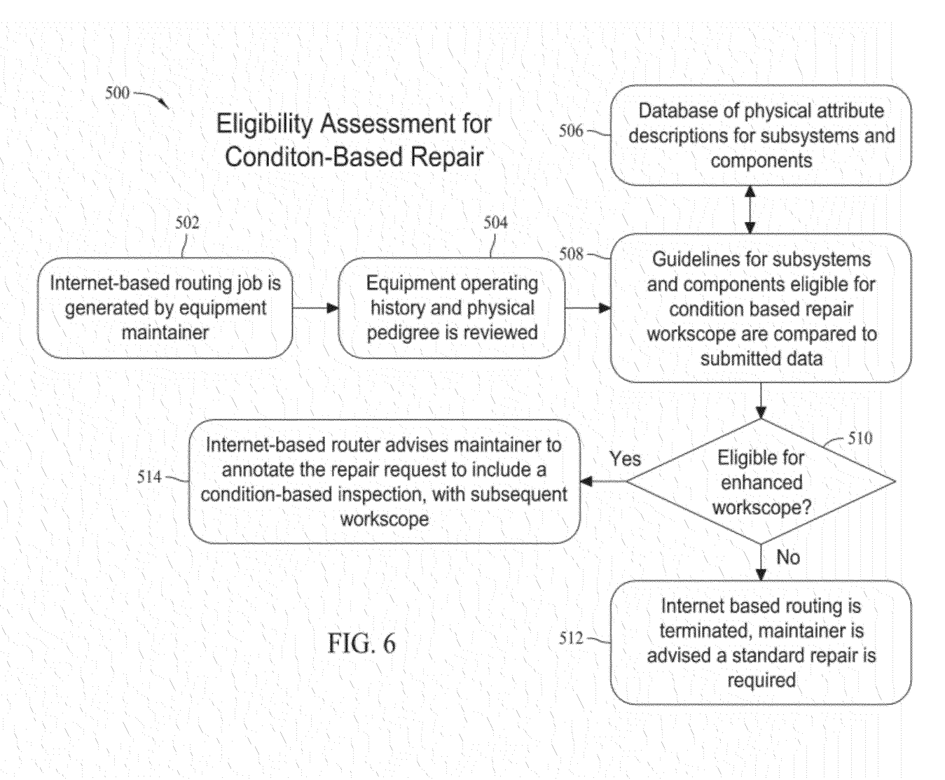

FIG. 6 is a flowchart of an exemplary method 500 of applying Internet-based component routing element 402 (shown in FIG. 5). In the exemplary embodiment, equipment maintainer 215 (shown in FIG. 2) logs into an Internet-based maintenance scheduling system, e.g., computer-based component workscope routing system 200 (shown in FIG. 2) and provides 502 pedigree information for the equipment maintained including, without limitation, combustor assembly 308, cap assembly 319, and transition piece 320 (all shown in FIG. 3). The data is transmitted to a relational database for storage on first database server 260 (shown in FIG. 2). Alternatively, the Internet-based maintenance scheduling system may include the database and may be stand-alone system that interfaces with system 200 via network 225 (shown in FIG. 2). Equipment maintainer 215 enters this data over a period of time preceding the maintenance event for the high-value assets, sometimes otherwise referred to as the outage planning process. Typical pedigree information data associated with components of the high-value assets includes, without limitation, a listing of all installed subsystems and components identified by engineering drawing specification and serialized manufacturing number, equipment/component model nomenclature (including nameplate data), aggregated time of operation, the number of startup/shutdown cycles, and other operational parameters associated with component performance and/or potential degradation, as a function of specific operational parameters.

Also, in the exemplary embodiment, computer-based component workscope routing system 200 then forwards the request to reviewer 225 (shown in FIG. 2) who reviews 504 the submitted data, followed by a query to a database, e.g., database server 260 that includes subsystem-specific and component-specific maintenance applicability guidelines resident therein. Alternatively, the maintenance applicability guidelines reside on any server loaded with a database application and the applicable maintenance applicability guidelines. Database server 260 returns 506 a set of subsystem and component descriptions to reviewer 225. The subsystem and component descriptions are specific to the specifications initially provided by equipment maintainer 215 in method step 502.

Further, in the exemplary embodiment, reviewer 225 compares 508 the physical attributes of the subsystem and components under evaluation with the attributes of subsystems and components that are eligible for a possible enhanced repair scope, as provided by the database. Reviewer 225 then determines 510 the eligibility of the submitted subsystems and components and enters the finding in system 200. For example, without limitation, cap assembly 319 may be eligible for an enhanced repair scope while transition piece 320 is not eligible.

Moreover, in the exemplary embodiment, for subsystems and components determined not to be eligible for an enhanced repair workscope, equipment maintainer 215 is advised to submit 512 a standard repair request to the service shop, e.g., repair shop personnel 245 (shown in FIG. 2) and the Internet workflow is then closed. In the cases where the subsystems and components submitted by equipment maintainer 215 are considered eligible for an enhanced repair, system 200 advises the equipment maintainer 215 to modify 514 the repair request to include a condition-based inspection with an enhanced repair workscope. System 200 then stores the request until subsequent inspection data is uploaded for analysis.

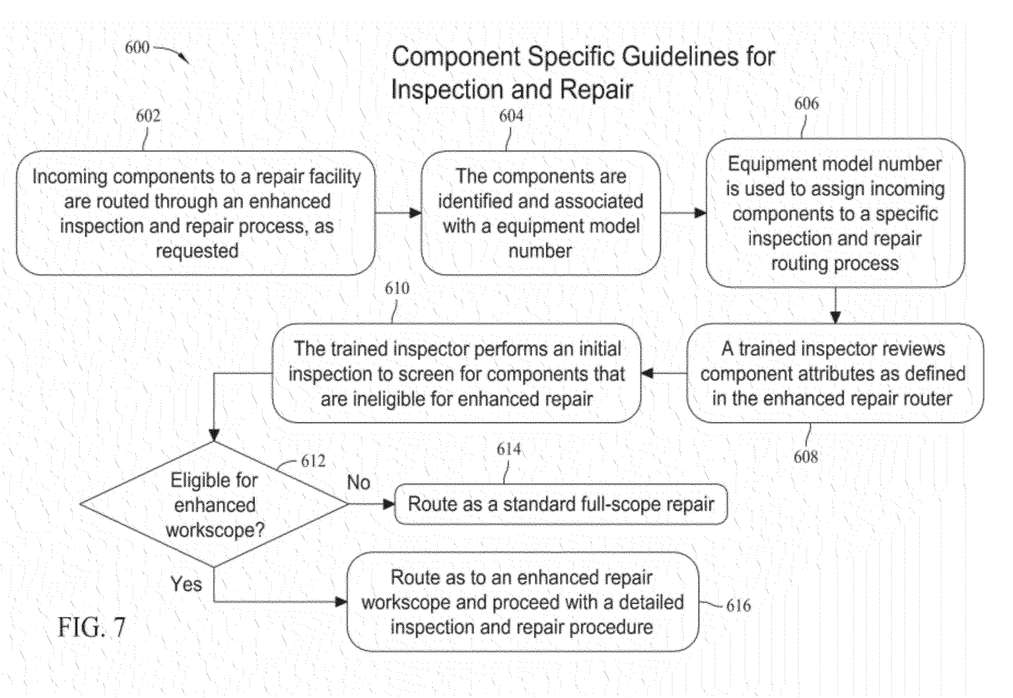

FIG. 7 is a flowchart of an exemplary method 600 of applying component-specific inspection and repair guidelines per inspection guidelines element 406 (shown in FIG. 5). In the exemplary embodiment, the eligible subsystems, e.g., combustor assembly 300, and the eligible components, e.g., cap assembly 319 and transition piece 320, all initially eligible for an enhanced repair workscope, arrive from equipment maintainer 215 with a request for an incoming inspection and condition-based enhanced repair workscope. The components are routed 602 to the incoming inspection in pursuit of the most economically efficient repair workscope such that component reliability is maintained upon completion of the enhanced repair procedure at the lowest cost.

Also, in the exemplary embodiment, the eligible subsystems and eligible components, and their attributes and functions, are initially identified and associated 604 with an equipment model number and the assessed guidelines per data entry element 408 (shown in FIG. 5). The equipment model number is used to query 606 a database, e.g., first database server 260 (shown in FIG. 2) for the appropriate repair routing instructions. The routing instructions include descriptions of the component's physical characteristics as described in method step 508 (shown in FIG. 6) and reviewed by reviewer 225 (shown in FIG. 2).

Further, in the exemplary embodiment, trained inspector 235 (shown in FIG. 2) reviews 608 the eligibility attributes and verifies the components under consideration are eligible for further routing to the enhanced repair scope. This second review of component attributes by inspector 235 is a redundancy designed to validate judgments of initial component eligibility made in method step 510 (shown in FIG. 6) by reviewer 225 for the eligibility of the submitted subsystems and components. Inspector 235 then performs 610 an initial inspection to screen for components that are ineligible for enhanced repair. Specifically, inspector 235 answers a predefined set of screening questions transmitted from first database server 260 (shown in FIG. 2). Inspector 235 determines 612 if the component, based on observed conditions defined by the screening question list, should proceed to a more detailed inspection, or undergo a standardized full-scope repair.

Moreover, in the exemplary embodiment, in the event that inspector 235 determines that the component will not be routed to an enhanced repair, inspector 235 routes 614 the component to the standard repair workscope and the component will be repaired to its full extent, in compliance with standard repair guidelines. Alternatively, in the event that inspector 235 determines that the component will be routed 616 to an enhanced repair workscope, the component is permitted to continue to the detailed inspection step, where repair workscope is generated according to the physical conditions of the inspected component. The costs of additional and unnecessary inspection, disassembly, and repairs are thereby avoided.

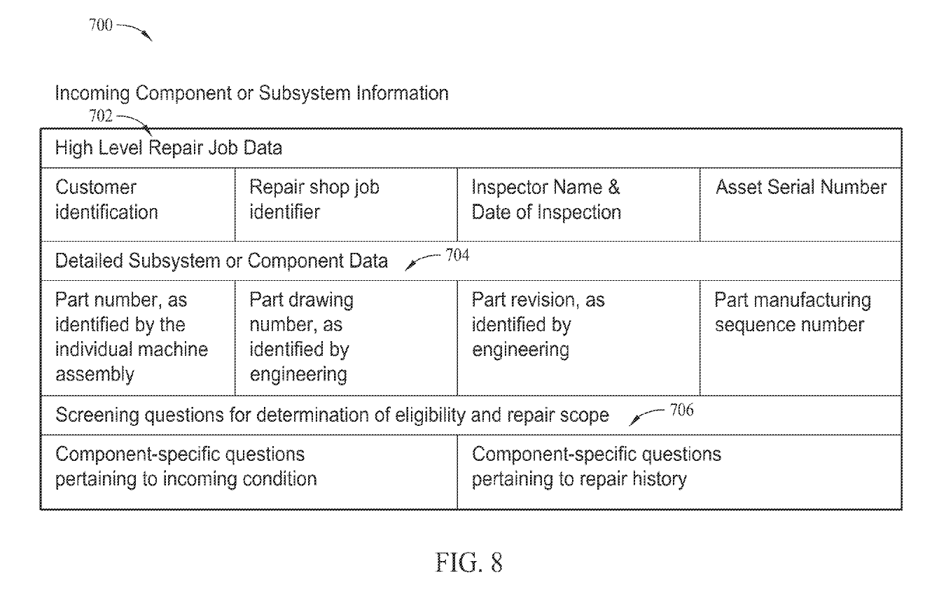

FIG. 8 is a table 700 of exemplary incoming component information and data structure used to facilitate data collection element 404 (shown in FIG. 5) and first data transfer element 410 (both shown in FIG. 5). Table 700 facilitates identifying incoming component data into three main categories. The first category includes a high-level repair job data section 702. Section 702 requests details including customer identification, model/ serial number of the high-value asset undergoing maintenance, the shop job identification number, and the name of inspector 235 who will recording the incoming condition of components. The second category includes a detailed subsystem or component data section 704. Section 704 requests details including all markings that identify component design, manufacture, and repair history. The third category includes a plurality of screening questions for determination of eligibility and repair scope section 706. Section 706 requests details via a list of component-specific questions created using prior knowledge of the components' known degradation modes, and a list of questions that determine repair histories derived from an internal and proprietary part marking system. Each component will have one of a set of known combinations of part marking that determine component repair history for a component-specific set of repair operations.

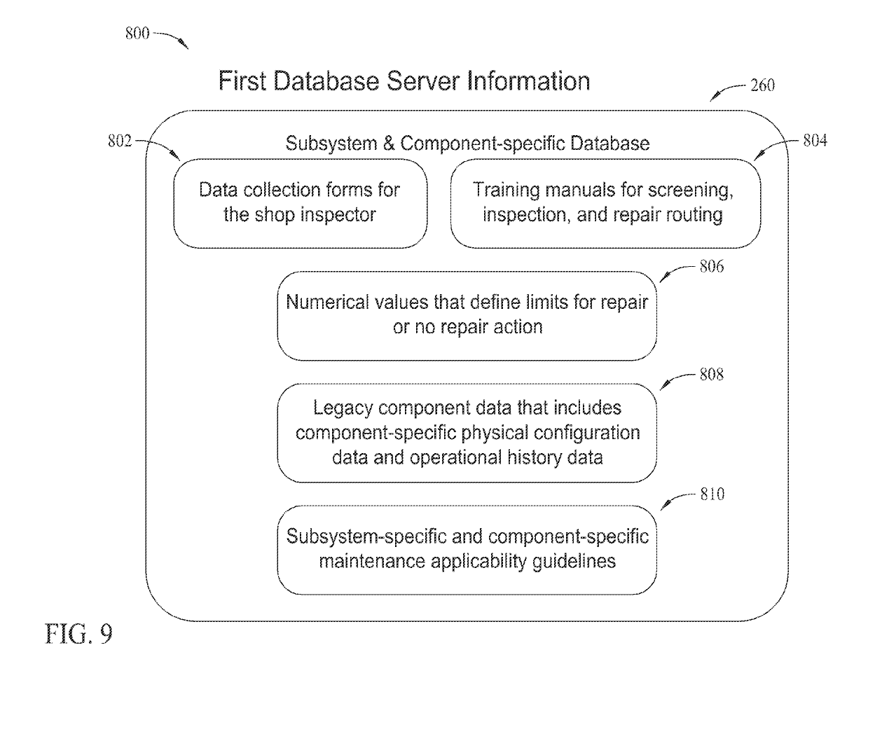

FIG. 9 is a diagram 800 of exemplary database information that may be stored on first database server 260 (shown in FIGS. 2 and 5). A first portion 802 of first database server 260 includes a relational database that includes, without limitation, inspection forms specific to the high-value asset and each subsystem and component therein, with screening questions and a listing of defects that are customized for each unique subsystem and component that may be used by inspector 235 (shown in FIG. 2).

A second portion 804 of first data base server 260 includes a relational database that includes, without limitation, instructions for repair shop personnel 245 (shown in FIG. 2) to properly screen and record defect data for a component to be repaired. These instructions include key attributes, e.g., without limitation, a listing of eligible components and a cross-referencing of key engineering part identifiers with physical component attributes, instructions for the proper marking of components upon the completion of all repairs, and a series of annotated images and schematics that describe the defects for which data is requested.

A third portion 806 of first database server 260 includes a relational database that includes, without limitation, a plurality of predefined defect parameters, e.g., defined numerically and specific to each defect type and component for which data is requested, e.g., quantitative definitions as to what constitutes a defect in a component that may be inspected by inspector 235.

A fourth portion 808 of first database 260 may include a relational database that includes, without limitation, records containing legacy component data that includes component-specific physical configuration data and operational history data existing at the time of a pre-inspection manual entry into system 200 by equipment maintainer 215 (both shown in FIG. 2). Such legacy component data may include, without limitation, performance and repair data that has been generated during prior reliability analyses. Such data may also include data referencing the components to a proprietary component marking scheme. Moreover, first database server 260 may include a fifth portion 810 that includes subsystem-specific and component-specific maintenance applicability guidelines that define those maintenance actions applicable to the associated subsystems and components, including, without limitation, a level of disassembly as described above.

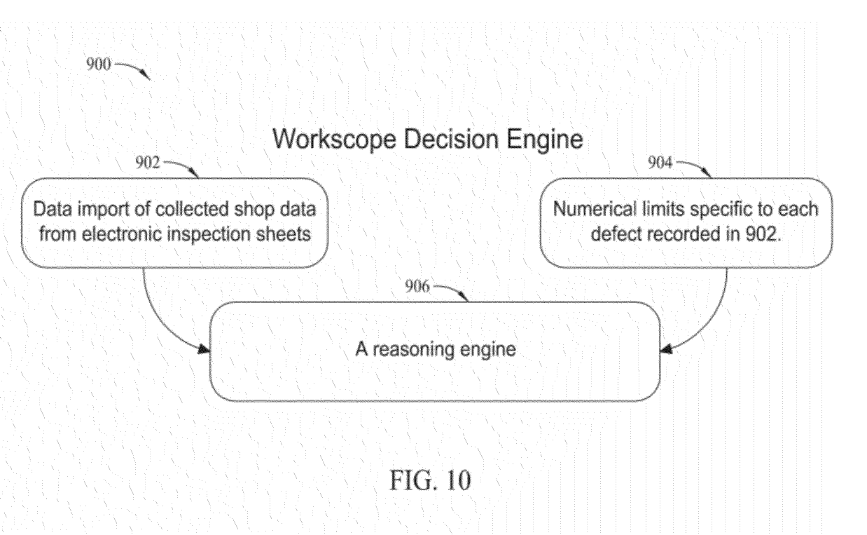

FIG. 10 is a flowchart of an exemplary workscope decision engine 900 per workscope decision engine 412 (shown in FIG. 5). Workscope decision engine 900 includes a data collection tool 902 implemented in both spreadsheet and internet-based forms, permitting convenient, alternative access points by which shop inspector 235 observations of component defects are recorded for further evaluation.

Workscope decision engine 900 also includes a component-specific defect listing 904. The creation of component-specific defect listings is a result of an exhaustive search of shop and field reports that chronicle component degradation as a function of usage. The result of this search provides the prior knowledge required to create a comprehensive listing of defects that influence the performance of the subsystem or component in question.

Workscope decision engine 900 further includes a reasoning engine module 906. This software module contains a series of logical rules that compare the inputs of tool 902 and listing 904, such that an output of defect specific pass/fail results. In addition, module 906 uses additional logic to concatenate all pass-fail results for summary according to each component specific repair category. Reasoning engine 906 also includes rules that govern the level of component disassembly, including the interaction of pass/fail criteria that interact with multiple repair categories and types.

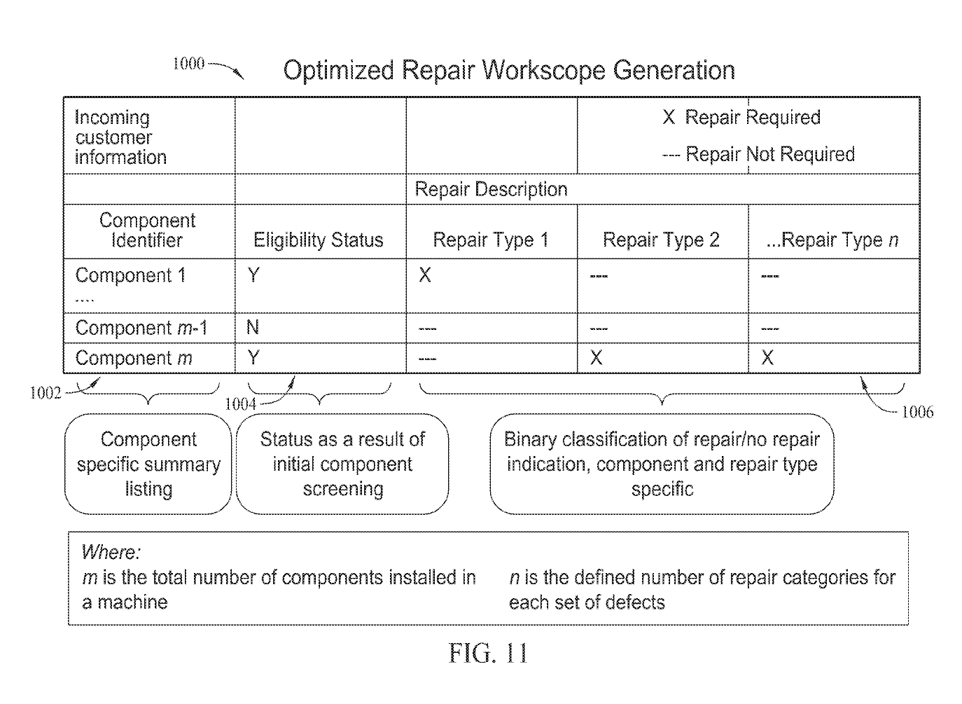

FIG. 11 is a table 1000 of an exemplary repair listing and routing that is used to facilitate customized component repair process 414 (shown in FIG. 5). Table 1000 includes a component identifier column 1002 that facilitates individual component tracking for multiple and/or redundant components. In a complex machine there may be multiple instances of a particular component, each instance of the component of the machine undergoing maintenance is listed for purposes of identification and tracking. Table 1000 also includes a eligibility status column 1004. For documentation and auditing purposes, the eligibility status of the component for the enhanced repair scope is shown in column 1004. Column 1004′s output is also used for the appropriate repair routing of each individual component. Table 1000 further includes a plurality of repair type columns 1006 that display to repair shop personnel, and an automated shop routing system, the customized repair workscope for each component, as a function of inspected condition. Columns 1006 include every available repair procedure for that component. The list of repair procedures is transmitted from second database server 270, thereby facilitating second data transfer 416 (shown in FIG. 5). Second database server 270 is programmed with a relational database that includes, without limitation, records containing repair procedures for the components and subsystems of the high-value assets.

In the exemplary embodiment, additional tracking features are included within computer-based component workscope routing system 200 (shown in FIG. 2). For example, expended resources to perform the noted enhanced repair workscope are automatically collected including, without limitation, repair personnel time, outsourced activities, and materials. Also, in the exemplary embodiment, such actual repair resource expenditures are compared to estimated repair resource expenditures.

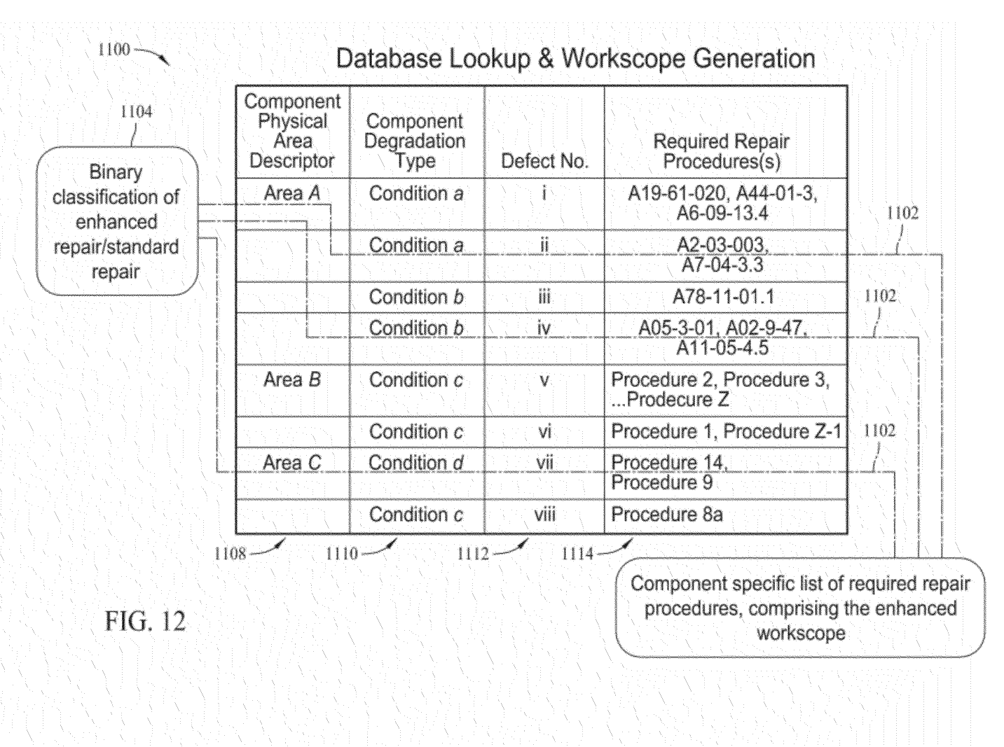

FIG. 12 is a diagram 1100 of exemplary enhanced repair workscope generation. The assignment of individual repair procedures, as a result of condition-based repair category classification, is embodied as a database within second database server 270 (shown in FIG. 2) with the ability to cross-reference component area descriptions, degradation type, defects, and standardized shop repair processes. The database includes all available repair procedures for the specified component or system, including the level to which the associate component should be disassembled. The workscope enhancement scheme implemented within workscope decision engine 500 (shown in FIG. 6), and list of procedures in columns 1006 (shown in FIG. 11), are used to reference appropriate procedures from second database server 270 and create the listing of detailed instructions for columns 1006. Computer-based component workscope routing system 200 includes software that performs the cross-referencing function, with the resulting list of required standardized repairs being presented to repair shop personnel for actual repair execution.

In the exemplary embodiment, a plurality of path lines 1102 show the relationship of a binary classification, or decision 1104 to route the affected subsystems and components to an enhanced repair workscope rather than a standard repair workscope. In the exemplary embodiment, path lines 1102 show the relationship between physical locations of the subsystem and/or components in the high-value asset 1108 with component-specific defect, or degradation types 1110, specific defects 1112, and the associated required repair procedures 1114 that are determined to facilitate a cost-effect repair to the specific defects 1112.

In contrast to known maintenance repair processes for large, complex, high-value assets that use standardized inspection and repair methods that are applied to all similar pieces of equipment, the enhanced repair workscope generated by the computer-based component workscope routing system, both as described herein, is a unique, customized, and enhanced workscope that includes a list of repairs based upon the incoming condition of the components. Moreover, in contrast to known maintenance repair processes, the embodiments of the system and processes as described herein significantly reduce maintenance repair activities that rely on uniformity of the inspection procedures as a function of the experience of an inspector, and/or their subjective interpretation of inspection guidelines. As a result, components having little or no defects may be processed as a function of their actual condition, rather than with a similar expenditure of resources as those components having significant defects. The reduced, more prudent expenditure of resources is optimal from a financial perspective and accordingly, the costs of maintenance overhauls may be substantially decreased with the elimination of unnecessary maintenance activities.

Embodiments of computer-based component workscope routing systems as provided herein facilitate the automatic generation of a repair workscope for individual components of a high-value asset, such as an industrial gas turbine. Such systems use electronic data collection and decision-making to generate a repair workscope based upon the incoming condition of a system or component, rather than a standard repair workscope. The systems as provided herein include a decision engine for determining the level of disassembly required, and the types of repairs that are to be performed. The systems also include data collection tools that interface with a computer application that stores the incoming inspection information, as well as the resulting repair workscope. This computer system also tracks actual time to job completion against initial estimates, entered by the user. The computer-based component workscope routing systems as provided herein are particularly suited for, and adaptable to, the repair of components for large assets, such as industrial gas turbines. Eliminating unnecessary maintenance activities for many subsystems and components, while maintaining the reliability of these components, can facilitate a large cumulative cost savings for operations and maintenance managers of such large assets.

An exemplary technical effect of the methods, systems, and apparatus described herein includes at least one of (a) creating workscope via observed defect information, combined with standardized defect limits and logic for disassembly and repair routing; (b) reducing the amount of subjective interpretation and unique, non-standard, yet relevant knowledge that is typically required in the determination of workscope for particular components, regardless of the experience levels of individual users; (c) standardizing subsystem and component screening; (d) generating repeatable and predictable processes for workscope generation, which in turn facilitates accurate predictions of repair costs over a product life cycle; and (e) reducing repair cost variability.

Described herein are exemplary embodiments of computer-based component workscope routing systems that facilitate cost-efficient maintenance of large, high-value assets by directing maintenance resources to known defects with known repair procedures. Specifically, the use of the systems as described herein facilitates generating a unique, cost-effective (enhanced) repair workscope based upon the incoming condition of a system or component, rather than a standard repair workscope. More specifically, the use of the systems as provided determine the level of disassembly required and the types of repairs that are to be performed on affected components. The enhanced workscope is generated using electronic data collection and decision-making with data collection tools that interface with a computer application that stores the incoming inspection information, as well as the resulting repair workscope. Use of the computer-based component workscope routing systems facilitates eliminating unnecessary maintenance activities for many subsystems and components. Streamlining maintenance activities as described herein can facilitate a large cumulative cost savings for operation and maintenance managers of such large assets.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

While the invention has been described in terms of various specific embodiments, those skilled in the art will recognize that the invention can be practiced with modification within the spirit and scope of the claims.

What is claimed is:

1. A method of determining component repair activities, said method comprising:
providing a computer-based component workscope routing system;
making a first determination of eligibility of a component for one of:
a standardized repair workscope that includes a plurality of predetermined standardized repair workscope activities; and
an enhanced repair workscope that includes at least one of:
a number of enhanced repair workscope activities that is less than a predetermined number of standardized repair workscope activities; and
inspection and repair activities that are different in scope from the plurality of standardized repair workscope activities; and
making a second determination of eligibility of the component for the standardized repair workscope or the enhanced repair workscope.

2. A method in accordance with claim 1, wherein making a first determination of eligibility of a component comprises:
logging on to a network-based maintenance scheduling system and inputting component-specific physical configuration data and operational history data;
comparing the data to enhanced repair workscope guidelines;
transmitting at least one manual pre-inspection entry into the computer-based component workscope routing system that determines eligibility for further evaluation of the component as a candidate for the enhanced repair workscope.

3. A method in accordance with claim 2, wherein comparing the data to enhanced repair workscope guidelines comprises providing responses to predefined screening questions.

4. A method in accordance with claim 1, wherein making a second determination of eligibility of a component comprises the computer-based component workscope routing system requesting a condition-based inspection of the component.

5. A method in accordance with claim 4, wherein requesting a condition-based inspection of the component comprises generating a repair workscope as a function of the condition-based inspection.

6. A method in accordance with claim 1, wherein making a second determination of eligibility of a component comprises importing component-related data into the computer-based workscope routing system.

7. A method in accordance with claim 6, wherein making a second determination of eligibility of a component comprises comparing the imported component-related data with results of an incoming inspection.

8. A method in accordance with claim 1, wherein making a second determination of eligibility of the component comprises routing the component to the enhanced repair workscope that is uniquely generated at least partially based on a determined physical condition of the component.

9. A network-based component workscope routing system, said system comprising at least one computing device comprising:
a memory device configured to store data associated with a component;
at least one input channel, said at least one input channel configured to receive the data associated with the component; and
a processor coupled to said memory device and said at least one input channel, said processor programmed to route the component to one of a standardized repair workscope and an enhanced repair workscope as a function of:
at least one pre-inspection manual entry into said network-based component workscope routing system via said at least one input channel that determines eligibility for further evaluation of the component as a candidate for said enhanced repair workscope; and
emergent post-inspection component data transmitted into said network-based component workscope routing system via said at least one input channel.

10. A system in accordance with claim 9, wherein said processor is further programmed to generate a unique, condition-based workscope that comprises:
types of repair activities; and
levels of disassembly to perform the repair activities.

11. A system in accordance with claim 10, wherein said processor is further programmed to generate the unique, condition-based workscope as a function of:
a plurality of predefined defect parameters;
emergent post-inspection component data comprising physical condition data of the component obtained from a final inspection; and
a comparison of the physical condition data and the plurality of predefined defect parameters.

12. A system in accordance with claim 9, wherein said at least one input channel is coupled to:
at least one database server comprising a first database comprising legacy component data existing at time of the at least one pre-inspection manual entry and a plurality of predefined defect parameters; and
at least one database server comprising a second database comprising repair procedures for the component, the repair procedures transmitted to said processor as a function of the physical condition data of the component obtained from a condition-based inspection compared to the predefined defect parameters.

13. A system in accordance with claim 9, wherein said processor is further programmed to compare actual repair resource expenditures to estimated repair resource expenditures.

14. A system in accordance with claim 9, wherein said processor is further programmed to request a condition-based inspection of the component.

15. One or more computer-readable storage media having computer-executable instructions embodied thereon, wherein when executed by at least one processor, the computer-executable instructions cause the at least one processor to:
generate a first determination that a component is eligible for one of a standardized repair workscope and an enhanced repair workscope based on a pre-inspection manual selection entry transmitted into the processor; and
generate a second determination that the component is eligible for one of the standardized repair workscope and the enhanced repair workscope at least partially based on:
legacy component data existing when the pre-inspection manual selection was entered; and
emergent post-inspection component data transmitted into the processor.

16. One or more computer-readable storage media in accordance with claim 15, wherein when executed by the at least one processor, the computer-executable instructions cause a condition-based inspection of the component to be requested.

17. One or more computer-readable storage media in accordance with claim 15, wherein when executed by the at least one processor, the computer-executable instructions cause facilitation of communications between the at least one processor and:
at least one database server comprising a first database comprising the legacy component data existing at time of the a pre-inspection manual entry and a plurality of predefined defect parameters; and
at least one database server comprising a second database comprising repair procedures for the component, the repair procedures transmitted to the processor as a function of the physical condition data of the component obtained from an incoming inspection compared to the predefined defect parameters.

18. One or more computer-readable storage media in accordance with claim 17, wherein when executed by the at least one processor, the computer-executable instructions cause generation of the unique, condition-based workscope as a function of:
the plurality of predefined defect parameters;
the emergent post-inspection component data comprising physical condition data of the component obtained from a condition-based inspection; and
a comparison of the physical condition data and the plurality of predefined defect parameters.

19. One or more computer-readable storage media in accordance with claim 15, wherein when executed by the at least one processor, the computer-executable instructions cause the component to be routed to repair personnel with detailed disassembly and repair procedures.

20. One or more computer-readable storage media in accordance with claim 19, wherein when executed by the at least one processor, the computer-executable instructions cause a comparison of actual repair resource expenditures to estimated repair resource expenditures.
